(19) United States
(12) Patent Application Publication
(10) Pub. No.: US 2009/0256028 A1
(43) Pub. Date: Oct. 15, 2009

(54) Fastening arrangement

(75) Inventors: Alexander Vorderwisch, Bielefeld (DE); Andreas Metten, Versmold (DE); Andreas Bertram, Herford (DE)

Correspondence Address: SEYFARTH SHAW LLP, 131 S. DEARBORN ST., SUITE 2400, CHICAGO, IL, 60603-5803, US

(73) Assignee: Bollhoff Verbindungstechnik GmbH

(21) Appl. No.: 12/383,401

(22) Filed: Mar. 24, 2009

(30) Foreign Application Priority Data
Mar. 26, 2008 (DE) 20 2008 004 151.1

(51) Int. Cl. B64C 1/12; B23P 11/00

(52) U.S. Cl. 244/132; 29/525.01

(57) ABSTRACT

The present invention discloses a two-part fastening arrangement for a surface element that is composed of a base element and a coupling element. The base element is constructed two-sided with a seat on its first side and a connecting pin projecting from its second side, with which a snap connection to the coupling element can be produced. The coupling element is also constructed two-sided with a seat on its first side and a pin receiver for the connecting pin of the base element on its second side, while the coupling element has an opening in which the pin receiver is resiliently arranged.

### TECHNICAL FIELD OF THE INVENTION

The present invention relates to a fastening arrangement for a surface element, especially for a protective plate in aircraft construction, which is composed of a base element and a coupling element.

### BACKGROUND OF THE INVENTION

Until now, aircraft fuselages were produced from aluminum sheets. These aluminum sheets perform a protective function against weather, and for example, chipping due to stones during takeoff and landing. These mechanical stresses are absorbed through energy absorption in the aluminum sheets. In the process, the aluminum sheets deform or buckle and protect the underlying fuselage structure.

In aircraft construction, as well as in other technical fields, carbon fiber reinforced plastic, CFRP, is being used increasingly. This applies, for example, to fuselage parts of aircraft, as well as to body parts of high speed trains or motor vehicles. The use of CFRP serves for weight reduction of the fuselage parts, as well as an improved stability of these parts.

However, CFRP is sensitive to mechanical stresses. For example, gravel striking a CFRP aircraft fuselage leads to a destruction of the inner layered structures of the CFRP component. Such destruction or damage can lead to the complete failure of the CFRP component. In addition, this damage is not visible from the exterior which makes damage analysis of the CFRP component more difficult. Therefore, it is necessary to protect the CFRP components in order to increase their service life. For this purpose, protective plates are installed in front of the fuselage components in aircraft construction.

The objective of the present invention is to provide a suitable fastening arrangement for, for example, these protective plates that reliably and simply connects the protective plates to, for example, a fuselage structure in aircraft construction.

### SUMMARY OF THE INVENTION

The above objective is solved through a fastening arrangement for a surface element, especially a protective plate in aircraft construction, according to the independent patent Claim 9. The fastening arrangement is composed of a base element according to the independent patent Claim 1, and a coupling element according to the independent patent Claim 5. Additionally, the above problem is solved by a mounting method according to independent Claim 10. Further advantageous embodiments of the present invention are given in the description of the accompanying drawings, and in the dependent claims.

The fastening arrangement according to the invention for a surface element, in particular, a protective plate in aircraft construction, comprises a base element and a coupling element that can be fastened together by means of a detachable or non-detachable snap connection. The base element of this two-part fastening arrangement has the following features: the base element is constructed two-sided with a seat on one side and a connecting pin projecting from the other side, with which a snap connection to the coupling element can be produced. The coupling element of the two-part fastening arrangement comprises the following features: the coupling element is also constructed two-sided with a seat on its first side and a pin receiver for the connecting pin of the base element on its second side, and the coupling element has an opening in which the pin receiver is resiliently arranged.

The base element and the coupling element are provided, in each case, as an areal component. These components have a low thickness compared to their areal extent, so that they can be described as components with only two sides. The base element, as well as the coupling element, has a seat. This seat is suitable and adapted in order to facilitate the production of an adhesive bond to adjacent additional components. While the base element has a connecting pin, the coupling element comprises a pin receiver constructed compatibly to the connecting pin, such that the base element and the coupling element can be connected together in a simple manner via a detachable or non-detachable snap connection by pressing them together. Thus, a multiplicity of base elements is bonded on a protective plate for a CFRP aircraft fuselage. In the same arrangement as the base elements, the compatible coupling elements are bonded to the CFRP fuselage. For fastening the protective plate to the CFRP fuselage, the individual base elements are secured on the appropriate coupling elements via the snap connection, and thus are fastened.

According to a preferred embodiment of the base element, the connecting pin is equipped with an undercut and a holding surface, and is fastened to the base element via a plurality of webs, while the seat is designed for the production of an adhesive bond. The plurality of webs of the connecting pin is fastened according to a preferred embodiment to an inner face of an opening in the seat of the base element. Additionally, the holding surface of the undercut of the connecting pin encloses an angle with at least one of the webs between 90° and 120°, preferably an angle of 90° or 100° to 110°.

In an expedient construction for the connecting pin, the coupling element comprises preferably a plurality of resiliently arranged snap hooks with a holding surface, while the holding surface encloses an angle of 90° to 120° with the longitudinal axis of the snap hook, preferably an angle of 90° or 100° to 110°.

The strength of the connection between the connecting pin and the pin receiver, that is, between the coupling element and the base element, can be adjusted through a suitable selection of the number and arrangement of the snap hooks. In addition, through the angular arrangement of the holding surface of the connecting pins and snap hooks relative to the respective longitudinal axes, it can be determined whether the snap connection produced between the base element and the coupling element is detachable or non-detachable. If the holding surface and the longitudinal axis of the connecting pin or snap hook enclose a right angle, the snap connection can no longer be detached by simply pulling the base element from the coupling element. However, if the angle between the longitudinal axis of the connecting pin and/or the snap hook and the respective holding surface is approximately 100° to 110° or greater, the connecting pin of the base element can be pulled out of the pin receiver of the coupling element. Thus, this type of construction of the connecting pin and pin receiver enables a non-destructive connection and detachment of the base element and coupling element of the fastening arrangement.

A further advantageous embodiment of the coupling element has an opening with an inner face to which spiral-shaped webs are fastened that resiliently hold the pin receiver in all three spatial directions. Additionally, it is preferable to arrange the pin receiver outside of the plane of the seat of the coupling element in order to enable a movement of the pin receiver perpendicular to the seat.

The inventive method for mounting a part to be mounted by means of a fastening arrangement on a supporting part, especially for mounting a protective plate on a CFRP-aircraft body or for retaining a car body or a covering part at a motor vehicle, comprises the following steps: bonding a plurality of base elements, in particular base elements as discussed above, in a predefined arrangement to the back side of a part to be mounted, particularly a protective plate, bonding a plurality of coupling elements, in particular coupling elements as discussed above, in an arrangement corresponding to the predefined arrangement to an outer side of a retaining part, in particular the outer side of a CFRP fuselage part, and fastening the parts to be mounted on the supporting part, in particular the protective plate on said CFRP fuselage, by applying a compressive force perpendicular to the face of the part to be mounted, particularly the protective plate, so that individual connecting pins of the base elements are snapped into the oppositely arranged pin receivers of the coupling elements. By means of the mounting method, particularly seat elements are mounted on supporting parts. While the base element and the coupling element are bonded to the supporting structure and the part to be mounted, respectively, the mounting of the part to be mounted is realized by a simple snap-in connection. To detach the mounted parts from the supporting part, only the snap-in connection has to be released.

### BRIEF DESCRIPTION OF THE ACCOMPANYING DRAWINGS

The present invention and preferred embodiments are explained in more detail with reference to the accompanying drawings.

FIG. 1 shows a preferred embodiment of the fastening arrangement with base element and coupling element in an exploded representation,

FIG. 2 shows the fastening arrangement from FIG. 1 in a different view,

FIG. 3 shows an enlarged section of the base element according to FIG. 1,

FIG. 4 shows an enlarged section of the connecting pin of the base element from FIG. 1,

FIG. 5 shows a further representation of the connecting pin from FIG. 1,

FIG. 6 shows an enlarged section of the coupling element from FIG. 1,

FIG. 7 shows an additional enlarged section of the coupling element from FIG. 1,

FIG. 8 shows an enlarged representation of the pin receiver from FIG. 1,

FIG. 9 shows an enlarged representation of the attachment of the spiral-shaped webs from FIG. 1, and

FIG. 10 shows a lateral representation of a section of the coupling element with snap hooks from FIG. 1.

### DETAILED DESCRIPTION OF PREFERRED EMBODIMENTS

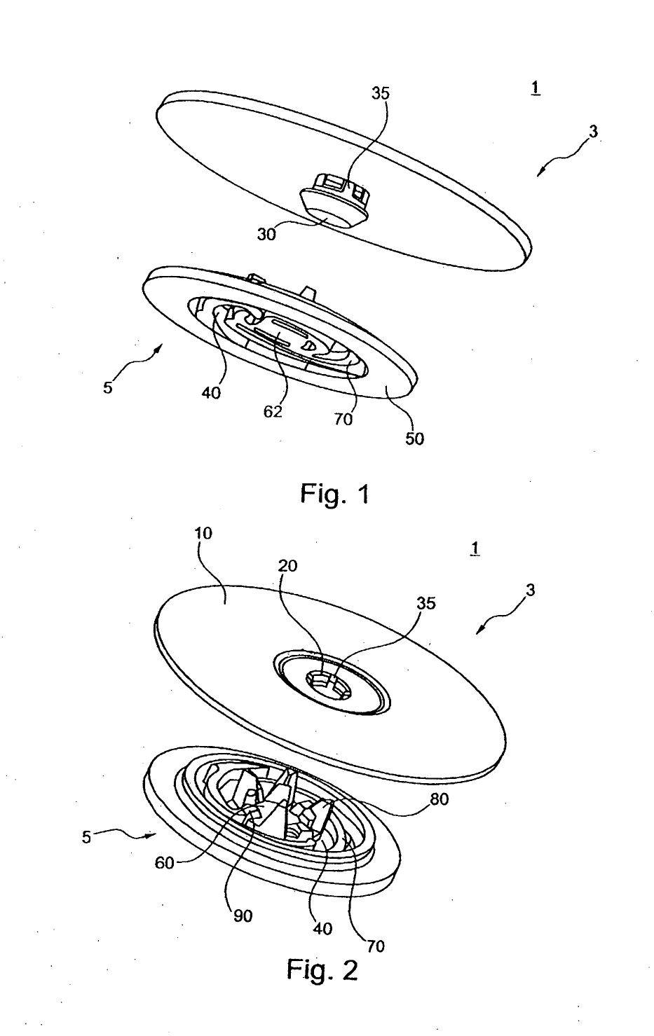

The FIGS. 1 and 2, respectively, show an exploded view of a preferred embodiment of the fastening arrangement 1 according to the invention. The fastening arrangement 1 is comprised of a base element 3 and a coupling element 5. The base element 3 and the coupling element 5 are produced from thermoplastic or similar materials. Preferably, an impact resistant modified polyamide plastic with a glass fiber portion is used. According to a different alternative, depending on the requirements of the fastening arrangement, it is also preferable to use a reinforcement other than the glass fiber portion, to vary the portion of reinforcing material, or to completely forgo the reinforcement.

The base element 3, just like the coupling element 5, is built essentially two-sided. That is, the thickness of the two parts 3, 5 is small in comparison to their lateral extent, or to the lateral dimensions of the base element 3 and the coupling element 5. Furthermore, the base element 3 and the coupling element 5 according to the embodiment shown here have a circular base area with a diameter of approximately 35-40 mm, like for instance, a plate. However, other shapes are conceivable for the base element 3 and the coupling element 5.

The base element 3 comprises a seat 10, whereas the seat of the coupling element 5 is designated as 50. Both seats 10, 50 are preferably adapted in order to produce an adhesive bond with the adjacent part. For this purpose, the seats 10, 50 have a smooth or rough surface, are provided with a suitable profile, or are coated with a suitable primer. Using these seats 10, 50, the base element 3 is bonded on a protective plate (not shown) according to the application. The coupling element 5 is bonded on a CFRP aircraft fuselage (not shown), in order to fasten detachably or non-detachably, the protective plate to the CFRP aircraft fuselage, using the fastening arrangement 1.

Double-sided adhesive bonding pads, for instance, can serve to produce the respective adhesive bond, or UV light-activated adhesive or similar alternatives, that guarantee a reliable connection.

Along with the reliable hold of protective plates to CFRP parts, or similar applications, the fastening arrangement 1 serves as an energy absorber and tolerance compensation. These functions are realized through specific design features of the base element 3 and the coupling element 5. The energy absorption serves to protect the CFRP parts that are connected to the coupling element 5. The energy absorption ensures that, for example, an application of mechanical energy to the protective plate due to stone chipping is not transferred via the base element 3 and the coupling element 5 to the CFRP part. Instead, webs 35 designed as predetermined break points of the connecting pins 30, break, or the pin receiver 60 yields resiliently. These constructive details and functions are described below in more detail.

Tolerance compensation between the protective plate and CFRP component is useful, among other reasons, due to the temperature differences for aircraft on the ground and in the air. The temperature difference leads to different expansions of materials that are adjacent to each other, which creates mechanical stresses in the fastening arrangement 1. These mechanical stresses are compensated, among others, by the webs 70 that extend in a spiral shape, and that hold the pin receiver 60 (see below). Thus, a solid material with resilient properties so that it does not break due to brittleness, is suited for the base element 3 and the coupling element 5.

The two-sided base element 3 comprises an opening 20 that is arranged preferably in the center of the plate-shaped base element 3. The connecting pin 30 is arranged above this opening 20. Thus, the connecting pin 30 projects from the side of the base element 3 that is facing away from the seat 10. The connecting pin 30 is connected to the base element 3 by a plurality of webs 35. It is also preferred to provide the base element 3 without the opening 20.

The number and the dimensions of the webs 35 determine which mechanical stresses the connecting pin 30 can withstand without breaking off. Such mechanical stresses arise through stone chipping on the protective plate that is bonded to the seat 10. The mechanical stresses create compressive forces in the direction of the longitudinal axis of the connecting pin 30 and therefore, also in the direction of the longitudinal axis of the webs 35. If no opening 20 is provided in the base element 30, these mechanical stresses create a compressive strain of the webs 35. With sufficiently high stress, the webs 35 break due to this compressive strain, whereby energy is absorbed and the CFRP fuselage part is not loaded by this energy. The mechanical stresses for the different applications of the fastening arrangement 1 are known. Therefore, the dimensions of the webs 35 can be adjusted such that the webs 35 break before too large a mechanical load is transferred, for example, to a CFRP fuselage part.

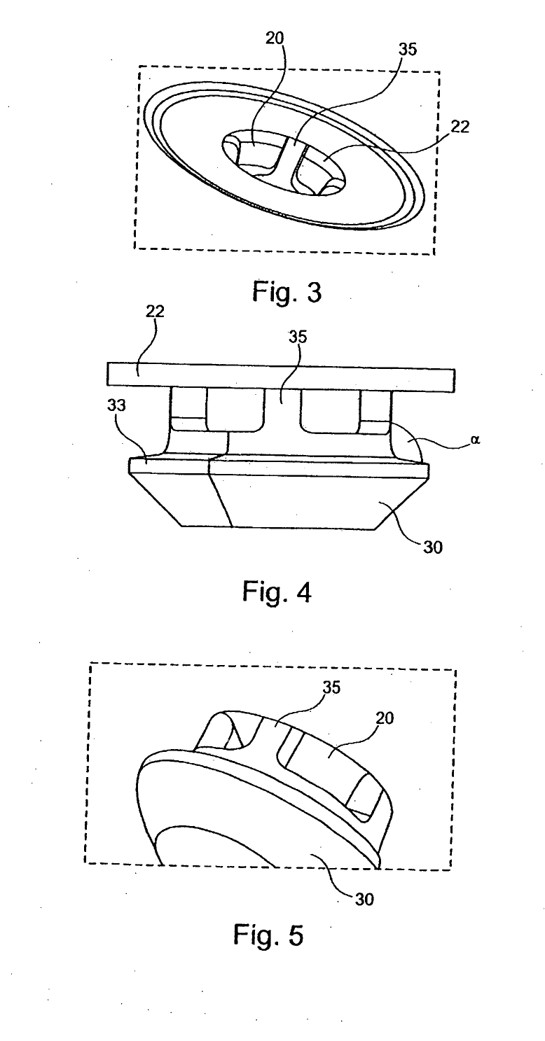

According to a further embodiment, the opening 20 is provided with an inner face 22 in the base element 3 (see FIGS. 3 and 5). The webs 35 are fastened to this inner face 22. If mechanical stresses occur on the protective plate, they are transferred via the seat 10 in the direction of the longitudinal axis of the connecting pin 30 into the pin. Through the fastening of the webs 35 to the inner face 22, a shear plane arises on the interface between webs 35 and inner face 22. Due to the mechanical stress introduced into the connecting pin 30, the size of said shear plane can determine the breaking point of the webs 35, and thus, of the connecting pin 30 and the fastening arrangement 1. The size of the shear plane can be specifically adjusted via the width of the web and the thickness of the base element 3.

Thus, the webs 35 of the connecting pin 30 serve as an intended break point of the fastening arrangement 1 in the case of mechanical stresses that are too large. At the same time, they also resiliently absorb loads below their maximum stress, and thereby support the stability of the fastening arrangement 1.

The connecting pin 30 is built preferably cone-shaped, as represented in FIG. 4. This facilitates an insertion of the connecting pin 30 into the pin receiver 60 (see below). Other designs are also conceivable as long as the connecting pin 30 can be reliably received in the pin receiver 60.

The connecting pin 30 has an undercut with a holding surface 33. After insertion of the connecting pin 30 in the pin receiver 60, snap hooks 80 (see FIGS. 2, 8, 10) engage behind the undercut. The holding surfaces 85 of the snap hooks 80 engage on the holding surface 33 of the undercut in order to optimally fasten the base element 3 to the coupling element 5. Preferably, the snap hooks 80 are adapted to the undercut of the connecting pin 30 so that a planar contact between the holding surfaces 33 and 85 results, and not a point-shaped or line-shaped contact.

The holding surface 33 of the connecting pin 30 and the longitudinal axis of at least one web 35 enclose an angle α as shown in FIG. 4. Depending on the size of the angle α, a detachable or non-detachable connection results between the base element 3 and the coupling element 5. Therefore, the angle α is preferably selected with a size of 90° to 120°. Corresponding to the angle α, an angle β between the longitudinal axis of the snap hook 80 and its holding surface 85 is similarly adapted (see FIGS. 8 and 10). The angle β has a similar size in the range of 90° to 120°. If both angles α and β have a size of 90°, a connection exists between the connecting pin 30 and the pin receiver 60 that can not be detached without destruction. If the two angles α and β, or only one of the two angles α and β, have a size in the range of 90°<α, β<120°, preferably a size between 100° and 110°, a connection exists between the connecting pin 30 and the pin receiver 60 that can be detached without destruction. The detaching of the connection occurs by pulling the connecting pin 30 out of the pin receiver 60, while the detaching of the connection is supported by an angle α and/or β that is as large as possible, preferably 120°.

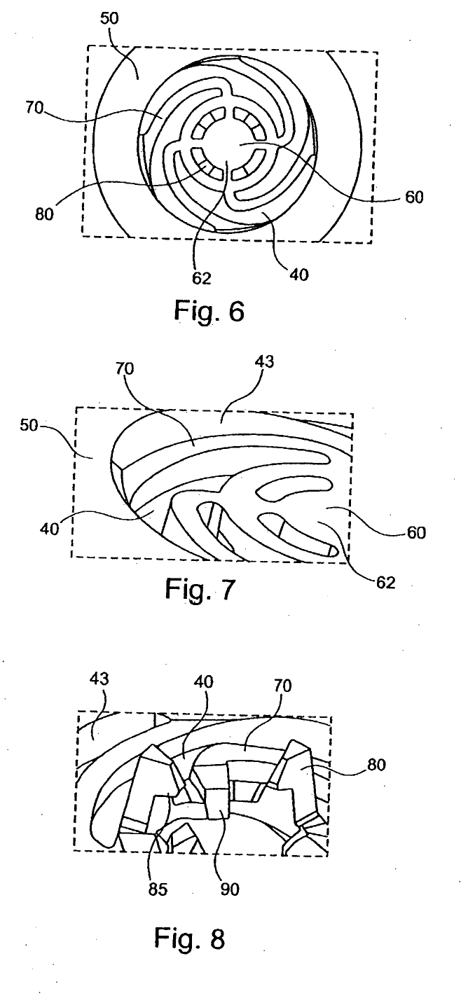

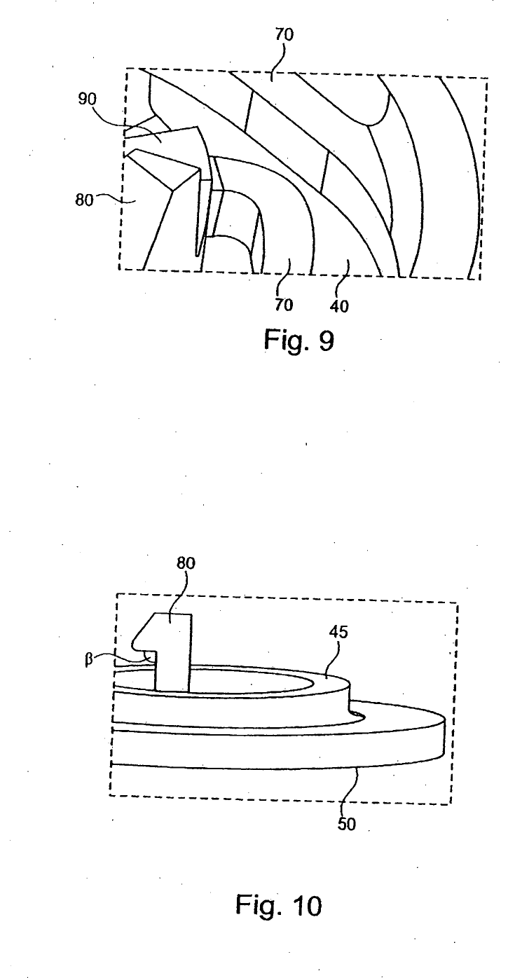

FIG. 6 shows a view of the coupling element 5, in a top view of the seat 50. The seat 50 is preferably ring-shaped around an opening 40 in the coupling element 5. Within the opening 40, the pin receiver 60 is resiliently arranged in all three spatial directions. This resilient arrangement is realized by flexible webs 70 that extend in a spiral shape. Due to their shape, the spiral-shaped webs 70 enable a yielding of the pin receiver 60 within the opening 40 in all three spatial directions. This design provides a tolerance compensation that compensates, for example, for a different expansion behavior of different materials.

As can be recognized in FIG. 7, the webs 70 that extend in a spiral shape are fastened to the inner face 43 of the opening 40. In order to guarantee a yielding of the pin receiver 60 perpendicular to the seat 50, the inner face 43 is preferably enlarged by a ring-shaped projection 45 on the edge of the opening 40. Through the enlarged inner face 43 the spiral-shaped webs 70 can be positioned and fastened to the inner face 43, such that the underside 62 of the pin receiver 60 is arranged outside of the plane of the seat 50. This enables a resilient yielding of the pin receiver 60 also in the direction of a CFRP fuselage part (not shown), bonded to the seat 50.

In addition, the pin receiver 60 preferably comprises centering webs 90. These are arranged concentrically around the center of the pin receiver 60. During insertion of the connecting pin 30 into the pin receiver 60, the centering webs align the connecting pin 30 within the pin receiver 60. For this reason, the shape of the centering webs 90 is preferably formed complementary to the contacting shape of the connecting pin 30.

A method for the application of the fastening arrangement 1, for example, to fasten protective plates to a CFRP aircraft fuselage or for holding body or cladding parts to vehicles, is summarized as follows. First, a plurality of base elements 3 is bonded to the back side of a protective plate in a predefined arrangement. Then, an equal number of coupling elements 5 is bonded to the outer side of the CFRP fuselage parts in a corresponding arrangement. Next, the protective plate is fastened to the CFRP fuselage part in that by applying a compressive force perpendicular to the face of the protective plate, the individual connecting pins 30 of the base elements 3 are snapped into the oppositely arranged pin receivers 60 of the coupling elements 5.

Depending on the bonding alternatives, already described above, the base element 3 and the coupling element 5 are fastened via different bonding methods to the protective plate and the CFRP fuselage part. Furthermore, the protective plates can be detached again from the CFRP fuselage part by using a suitable form of undercut and snap hook, in that the fastening arrangement is loaded by pulling in the direction of the longitudinal axis of the connecting pin 30.

What is claimed is:

1. A base element of a two-part fastening arrangement for a surface element, especially a protective plate in aircraft construction, that has the following features:
a. the base element is built two-sided with
b. a seat on its first side and a connecting pin projecting from its second side,
c. with which a snap connection to a coupling element can be produced.

2. The base element according to claim 1, whose connecting pin has an undercut with a holding surface, and that is fastened to the base element by means of a plurality of webs, and whose seat is designed for producing an adhesive bond.

3. The base element according to claim 2, whose seat has an opening with an inner face, to which a plurality of webs is fastened.

4. The base element according to claim 2, whose holding surface of the undercut of the connecting pin encloses an angle with at least one of the webs of between 90° and 120°, preferably an angle of 90° or 100° to 110°.

5. A coupling element of a two-part fastening arrangement for a surface element, especially a protective plate in aircraft construction, that has the following features:
a. the coupling element is built two-sided with
b. a seat on its first side, and
c. a pin receiver for a connecting pin of a base element on its second side, while
d. the coupling element has an opening in which the pin receiver is resiliently arranged.

6. The coupling element according to claim 5, whose pin receiver has a plurality of resiliently arranged snap hooks with a holding surface, while the holding surface encloses with the longitudinal axis of the snap hook an angle of 90° to 120°, preferably an angle of 90° or 100 to 110°.

7. The coupling element according to claim 5, whose opening has an inner face to which webs that extend in a spiral shape are fastened, and that hold the pin receiver resiliently in all three spatial directions.

8. The coupling element according to claim 5, whose pin receiver is arranged outside of the plane of the seat in order to allow a movement of the pin receiver perpendicular to the seat, while the seat is designed for producing an adhesive bond.

9. A fastening arrangement for a surface element, especially a protective plate in aircraft construction, that has a base element according to claim 1, and a coupling element according to claim 5, which can be fastened together by a detachable or a non-detachable snap connection.

10. Method for mounting a part to be mounted by means of a fastening arrangement on a supporting part, especially for mounting a protective plate on a CFRP-aircraft body or for retaining a car body or a covering part at motor vehicles, which comprises the following steps:
a. bonding a plurality of base elements in a predefined arrangement to the back side of a part to be mounted, particularly a protective plate,
b. bonding a plurality of coupling elements in an arrangement corresponding to the predefined arrangement to an outer side of a retaining part, in particular the outer side of a CFRP fuselage part, and
c. fastening the parts to be mounted on the supporting part, in particular the protective plate on said CFRP fuselage, by applying a compressive force perpendicular to the face of the part to be mounted, particularly the protective plate, so that individual connecting pins of the base elements are snapped into the oppositely arranged pin receivers of the coupling elements.

11. Method according to claim 10, in which the bonding is realized by applying double-sided adhesive pads and/or by applying an adhesive which can be activated by ultraviolet light.
